(19) United States
(12) Patent Application Publication
(10) Pub. No.: US 2024/0062950 A1
(43) Pub. Date: Feb. 22, 2024

(54) INDUCTOR COMPONENT

(71) Applicant: Murata Manufacturing Co., Ltd., Kyoto-fu (JP)

(72) Inventor: Kiyotaka NISHI, Nagaokakyo-shi (JP)

(73) Assignee: Murata Manufacturing Co., Ltd., Kyoto-fu (JP)

(21) Appl. No.: 18/452,929

(22) Filed: Aug. 21, 2023

(30) Foreign Application Priority Data
Aug. 22, 2022 (JP) 2022-131800

(51) Int. Cl. H01F 27/29; H01F 27/28; H01F 17/00; H01F 27/32

(52) U.S. Cl. CPC H01F 27/292; H01F 27/2823; H01F 17/0013; H01F 27/323

(57) ABSTRACT

An inductor component includes an element body and an inductor wiring in the element body. When viewed in a direction perpendicular to a first main surface, the inductor wiring has a circling path wound one or more turns. The element body includes a main body having an insulating property and a first covering layer having optical properties different from those of the main body. The first covering layer is parallel to the first main surface, and is on the first main surface side with respect to an end of the circling path on the first main surface side. When viewed in a direction perpendicular to the first main surface, the first covering layer overlaps the entire circling path, and a range surrounded by an outer edge of the first covering layer is smaller than a range surrounded by an outer edge of the main body.

### CROSS-REFERENCE TO RELATED APPLICATION

This application claims benefit of priority to Japanese Patent Application No. 2022-131800, filed Aug. 22, 2022, the entire content of which is incorporated herein by reference.

### BACKGROUND

### Technical Field

The present disclosure relates to an inductor component.

### Background Art

An electronic component described in Japanese Patent Application Laid-Open No. 2011-014940 includes an element body and an internal electrode layer located inside the element body. The element body has a rectangular parallelepiped shape having six outer surfaces. The element body includes a main body and a covering layer. The covering layer is made of a material different from that of the main body. The covering layer covers the entire outer surface of one of the six outer surfaces of the main body. That is, one of the six outer surfaces is made of only the covering layer.

### SUMMARY

In the electronic component as described in Japanese Patent Application Laid-Open No. 2011-014940, the outer edge of the covering layer is located at the boundary between the outer surface and the outer surface, that is, at the corner of the element body. The corner of the element body is a portion that easily collides with another object. Therefore, when the element body collides with another object, the outer edge of the covering layer easily collides with another object. Since the covering layer and the main body have different materials, the close contact force with the main body may be lower than the strength inside the main body. Therefore, if the outer edge of the covering layer collides with another object, the covering layer may be peeled off from the main body with the outer edge as a starting point.

Accordingly, the present disclosure provides an inductor component including: an element body; and an inductor wiring extending inside the element body. One flat surface of outer surfaces of the element body is defined as a main surface. When viewed in a direction perpendicular to the main surface, the inductor wiring has a circling path wound one or more turns. The element body includes a main body having an insulating property and a covering layer having optical properties different from optical properties of the main body and parallel to a first surface that is one flat surface of the outer surfaces of the element body. The covering layer is located on the first surface side with respect to an end of the circling path on the first surface side. Also, when viewed in a direction perpendicular to the first surface, the covering layer overlaps the entire circling path, and a range surrounded by an outer edge of the covering layer is smaller than a range surrounded by an outer edge of the main body.

According to the above configuration, when the inductor component is viewed in a direction perpendicular to the first surface, a part of the outer edge of the covering layer does not coincide with the outer edge of the main body. Therefore, it is possible to reduce the probability that the inductor component directly collides with another object so that a force is applied parallel to the contact surface between the covering layer and the main body. Therefore, it is possible to suppress peeling of the covering layer from the main body with the outer edge of the covering layer as a starting point.

It is possible to suppress peeling of the covering layer from the main body.

### BRIEF DESCRIPTION OF THE DRAWINGS

FIG. 1 is a perspective view of an inductor component of an embodiment;

FIG. 2 is an exploded perspective view of the inductor component of the embodiment;

FIG. 3 is a transparent plan view of the inductor component of the embodiment;

FIG. 4 is an exploded perspective view of an inductor component of a modification;

FIG. 5 is a plan view of an inductor component of a modification; and

FIG. 6 is a perspective view of an inductor component of a modification.

### DETAILED DESCRIPTION

### Embodiment

In the following, an embodiment of an inductor component will be described. The drawings may show enlarged components to facilitate understanding. The dimensional ratios of the components may be different from the actual ones or those in another drawing.

<Overall Configuration>

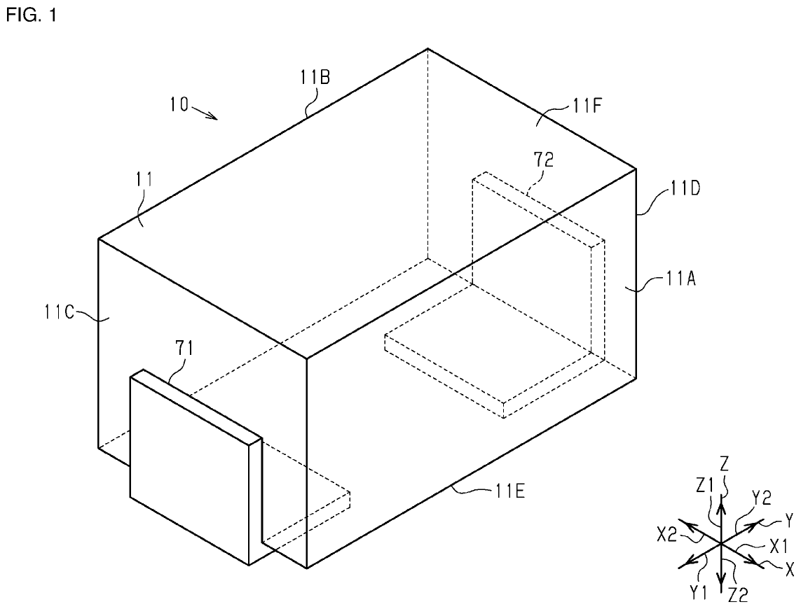

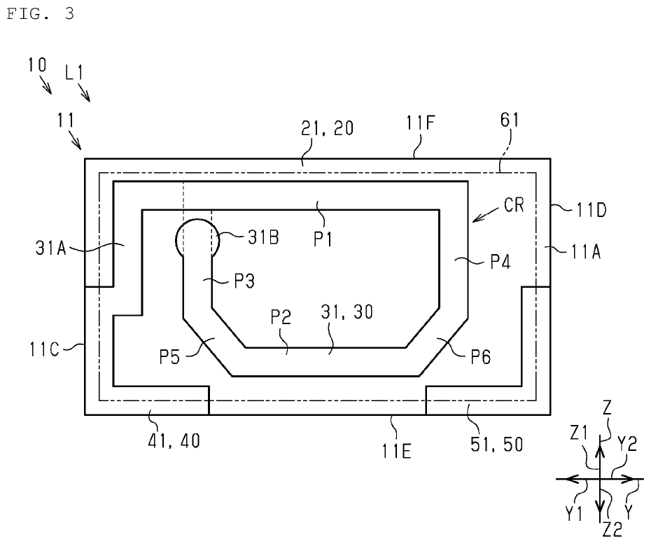

As illustrated in FIG. 1, an inductor component 10 includes an element body 11 having a rectangular parallelepiped shape. As illustrated in FIG. 3, the inductor component 10 includes an inductor wiring 30 extending inside the element body 11, a first electrode 40 connected to a first end of the inductor wiring 30, and a second electrode 50 connected to a second end of the inductor wiring 30.

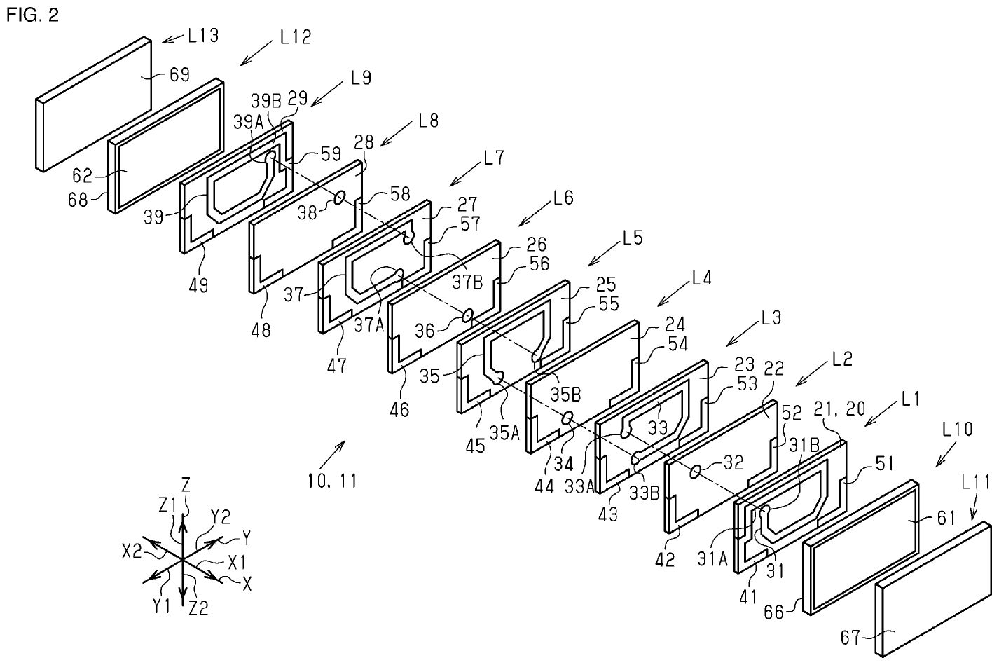

As illustrated in FIG. 2, the element body 11 has a structure in which a plurality of plate-shaped layers are laminated as a whole. Each layer has a rectangular shape in plan view. Since the element body 11 has a rectangular parallelepiped shape, it has six outer surfaces. The six outer surfaces are all flat surfaces. As illustrated in FIG. 1, among these six outer surfaces, one specific flat surface parallel to the main surface of each layer is defined as a first main surface 11A. A flat surface parallel to the first main surface 11A is defined as a second main surface 11B. One specific flat surface perpendicular to first main surface 11A is defined as a first end surface 11C. A surface parallel to the first end surface 11C is defined as a second end surface 11D. Further, one specific flat surface perpendicular to both the first main surface 11A and the first end surface 11C is defined as a bottom surface 11E. A surface parallel to the bottom surface 11E is defined as a top surface 11F.

In the following description, an axis along a direction in which a plurality of layers are laminated, that is, an axis perpendicular to the first main surface 11A is defined as a first axis X. An axis perpendicular to the first end surface 11C is defined as a second axis Y. Further, an axis perpendicular to the bottom surface 11E is defined as a third axis Z. Of the directions along the first axis X, a direction in which the first main surface 11A faces is defined as a first positive direction X1, and a direction opposite to the first positive direction X1 is defined as a first negative direction X2. Of the directions along the second axis Y, a direction in which the first end surface 11C faces is defined as a second positive direction Y1, and a direction opposite to the second positive direction Y1 is defined as a second negative direction Y2. Furthermore, of the directions along the third axis Z, a direction in which the top surface 11F faces is defined as a third positive direction Z1, and a direction opposite to the third positive direction Z1 is defined as a third negative direction Z2.

As illustrated in FIG. 2, the element body 11 includes a first layer L1 to a ninth layer L9. The first layer L1 to the ninth layer L9 are arranged in this order in the first negative direction X2. The thicknesses of the first layer L1 to the ninth layer L9, that is, the dimensions in the direction along the X axis are all substantially the same. As illustrated in FIG. 3, the first layer L1 includes a first electrode portion 41, a second electrode portion 51, a first wiring portion 31, and a first insulating portion 21. In FIG. 3, the first layer L1 is indicated by a solid line.

The first electrode portion 41 is made of a conductive material such as silver. When the first layer L1 is viewed in the first negative direction X2, the first electrode portion 41 has an L shape as a whole. When the first layer L1 is viewed in the first negative direction X2, the first electrode portion 41 is located on the second positive direction Y1 side and the third negative direction Z2 side with respect to the center of the first layer L1. More specifically, when the first layer L1 is viewed in the first negative direction X2, the first electrode portion 41 is located at a position including a corner on the second positive direction Y1 side and the third negative direction Z2 side of the first layer L1.

The second electrode portion 51 is made of a conductive material such as silver. When the first layer L1 is viewed in the first negative direction X2, the second electrode portion 51 has an L shape as a whole. When the first layer L1 is viewed in the first negative direction X2, the second electrode portion 51 is located on the second negative direction Y2 side and the third negative direction Z2 side with respect to the center of the first layer L1. That is, when the first layer L1 is viewed in the first negative direction X2, the second electrode portion 51 is located at a position including a corner on the second negative direction Y2 side and the third negative direction Z2 side with respect to the center of the first layer L1.

The first wiring portion 31 is made of a conductive material such as silver. When the first layer L1 is viewed in the first negative direction X2, the first wiring portion 31 extends as a whole in a spiral shape with the center of the first layer L1 as a substantial center. Specifically, a first end portion 31A of the first wiring portion 31 is connected to an end portion of the first electrode portion 41 on the third positive direction Z1 side in the direction along the third axis Z. That is, the first end portion 31A is a first end of the inductor wiring 30. The wiring width of the first wiring portion 31 is substantially constant except for a second end portion 31B. The position of the second end portion 31B of the first wiring portion 31 in the direction along the third axis Z is on the third positive direction Z1 side from the center of the first layer L1 in the direction along the third axis Z. The position of the second end portion 31B of the first wiring portion 31 in the direction along the second axis Y is on the second positive direction Y1 side from the center of the first layer L1 in the direction along the second axis Y. When the first wiring portion 31 is viewed in the first negative direction X2, the first wiring portion 31 extends clockwise from the first end portion 31A toward the second end portion 31B.

The second end portion 31B of the first wiring portion 31 functions as a pad for connection with a via 32 to be described later. When the first layer L1 is viewed in the first negative direction X2, the second end portion 31B has a substantially circular shape. The second end portion 31B of the first wiring portion 31 has a wiring width larger than that of the other portions of the first wiring portion 31.

In the first layer L1, a portion excluding the first electrode portion 41, the second electrode portion 51, and the first wiring portion 31 is the first insulating portion 21. The first insulating portion 21 is made of a nonmagnetic insulator such as glass, resin, or alumina. The first insulating portion 21 is colorless and transparent under visible light.

As illustrated in FIG. 2, the second layer L2 is laminated on the main surface of the first layer L1 facing the first negative direction X2. When the second layer L2 is viewed in the first negative direction X2, the second layer L2 has the same rectangular shape as the first layer L1. The second layer L2 includes a third electrode portion 42, a fourth electrode portion 52, the via 32, and a second insulating portion 22.

The third electrode portion 42 is made of the same material as the first electrode portion 41. When the second layer L2 is viewed in the first negative direction X2, the third electrode portion 42 has an L shape having the same dimension as the first electrode portion 41. When the second layer L2 is viewed in the first negative direction X2, the third electrode portion 42 is located at the same position as the first electrode portion 41. Therefore, the third electrode portion 42 is laminated on the surface of the first electrode portion 41 facing the first negative direction X2.

The fourth electrode portion 52 is made of the same material as the second electrode portion 51. When the second layer L2 is viewed in the first negative direction X2, the fourth electrode portion 52 has an L shape having the same dimension as the second electrode portion 51. When the second layer L2 is viewed in the first negative direction X2, the fourth electrode portion 52 is located at the same position as the second electrode portion 51. Therefore, the fourth electrode portion 52 is laminated on the surface of the second electrode portion 51 facing the first negative direction X2.

The via 32 is made of the same material as the first wiring portion 31. The via 32 has a columnar shape extending in the direction along the first axis X. The via 32 is laminated on a surface of the second end portion 31B of the first wiring portion 31 facing the first negative direction X2. Therefore, the via 32 is electrically connected to the second end portion 31B of the first wiring portion 31. The via 32 extends from the second end portion 31B of the first wiring portion 31 in the first negative direction X2.

In the second layer L2, a portion excluding the third electrode portion 42, the fourth electrode portion 52, and the via 32 is the second insulating portion 22. The second insulating portion 22 is made of a nonmagnetic insulator of the same material as the first insulating portion 21.

The third layer L3 is laminated on the main surface of the second layer L2 facing the first negative direction X2. When the third layer L3 is viewed in the first negative direction X2, the third layer L3 has the same rectangular shape as the first layer L1. The third layer L3 includes a fifth electrode portion 43, a sixth electrode portion 53, a second wiring portion 33, and a third insulating portion 23.

The fifth electrode portion 43 is made of the same material as the first electrode portion 41. When the third layer L3 is viewed in the first negative direction X2, the fifth electrode portion 43 has an L shape having the same dimension as the third electrode portion 42. When the third layer L3 is viewed in the first negative direction X2, the fifth electrode portion 43 is located at the same position as the third electrode portion 42. Therefore, the fifth electrode portion 43 is laminated on the surface of the third electrode portion 42 facing the first negative direction X2.

The sixth electrode portion 53 is made of the same material as the second electrode portion 51. When the third layer L3 is viewed in the first negative direction X2, the sixth electrode portion 53 has an L shape having the same dimension as the fourth electrode portion 52. When the third layer L3 is viewed in the first negative direction X2, the sixth electrode portion 53 is located at the same position as the fourth electrode portion 52. Therefore, the sixth electrode portion 53 is laminated on the surface of the fourth electrode portion 52 facing the first negative direction X2.

The second wiring portion 33 is made of the same material as the first wiring portion 31. When the third layer L3 is viewed in the first negative direction X2, the second wiring portion 33 extends as a whole in a spiral shape with the center of the third layer L3 as a substantial center. Specifically, the position of a first end portion 33A of the second wiring portion 33 is on the surface of the via 32 facing the first negative direction X2. Therefore, the first end portion 33A of the second wiring portion 33 is connected to the via 32. The wiring width of the second wiring portion 33 is substantially constant except for the first end portion 33A and a second end portion 33B. The position of the second end portion 33B of the second wiring portion 33 in the direction along the third axis Z is on the third negative direction Z2 side from the center of the third layer L3 in the direction along the third axis Z. The position of the second end portion 33B of the second wiring portion 33 in the direction along the second axis Y is on the second positive direction Y1 side from the center of the third layer L3 in the direction along the second axis Y. Furthermore, the position of the second end portion 33B of the second wiring portion 33 in the direction along the second axis Y is on the center side in the direction along the second axis Y from the position of the second end portion 31B of the first wiring portion 31 in the direction along the second axis Y. When the second wiring portion 33 is viewed in the first negative direction X2, the second wiring portion 33 extends clockwise from the first end portion 33A toward the second end portion 33B.

In the third layer L3, a portion excluding the fifth electrode portion 43, the sixth electrode portion 53, and the second wiring portion 33 is the third insulating portion 23. The third insulating portion 23 is made of a nonmagnetic insulator of the same material as the first insulating portion 21.

The fourth layer L4 is laminated on the main surface of the third layer L3 facing the first negative direction X2. When the fourth layer L4 is viewed in the first negative direction X2, the fourth layer L4 has the same rectangular shape as the first layer L1. The fourth layer L4 includes a seventh electrode portion 44, an eighth electrode portion 54, a via 34, and a fourth insulating portion 24.

The seventh electrode portion 44 is made of the same material as the first electrode portion 41. When the fourth layer L4 is viewed in the first negative direction X2, the seventh electrode portion 44 has an L shape having the same dimension as the fifth electrode portion 43. When the fourth layer L4 is viewed in the first negative direction X2, the seventh electrode portion 44 is located at the same position as the fifth electrode portion 43. Therefore, the seventh electrode portion 44 is laminated on the surface of the fifth electrode portion 43 facing the first negative direction X2.

The eighth electrode portion 54 is made of the same material as the second electrode portion 51. When the fourth layer L4 is viewed in the first negative direction X2, the eighth electrode portion 54 has an L shape having the same dimension as the sixth electrode portion 53. When the fourth layer L4 is viewed in the first negative direction X2, the eighth electrode portion 54 is located at the same position as the sixth electrode portion 53. Therefore, the eighth electrode portion 54 is laminated on the surface of the sixth electrode portion 53 facing the first negative direction X2.

The via 34 is made of the same material as the first wiring portion 31. The via 34 has a columnar shape extending in the direction along the first axis X. The via 34 is laminated on a surface of the second end portion 33B of the second wiring portion 33 facing the first negative direction X2. Therefore, the via 34 is electrically connected to the second end portion 33B of the second wiring portion 33. The via 34 extends from the second end portion 33B of the second wiring portion 33 in the first negative direction X2.

In the fourth layer L4, a portion excluding the seventh electrode portion 44, the eighth electrode portion 54, and the via 34 is the fourth insulating portion 24. The fourth insulating portion 24 is made of a nonmagnetic insulator of the same material as the first insulating portion 21.

The fifth layer L5 is laminated on the main surface of the fourth layer L4 facing the first negative direction X2. When the fifth layer L5 is viewed in the first negative direction X2, the fifth layer L5 has the same rectangular shape as the first layer L1. The fifth layer L5 includes a ninth electrode portion 45, a tenth electrode portion 55, a third wiring portion 35, and a fifth insulating portion 25.

The ninth electrode portion 45 is made of the same material as the first electrode portion 41. When the fifth layer L5 is viewed in the first negative direction X2, the ninth electrode portion 45 has an L shape having the same dimension as the seventh electrode portion 44. When the fifth layer L5 is viewed in the first negative direction X2, the ninth electrode portion 45 is located at the same position as the seventh electrode portion 44. Therefore, the ninth electrode portion 45 is laminated on the surface of the seventh electrode portion 44 facing the first negative direction X2.

The tenth electrode portion 55 is made of the same material as the second electrode portion 51. When the fifth layer L5 is viewed in the first negative direction X2, the tenth electrode portion 55 has an L shape having the same dimension as the eighth electrode portion 54. When the fifth layer L5 is viewed in the first negative direction X2, the tenth electrode portion 55 is located at the same position as the second electrode portion 51. Therefore, the tenth electrode portion 55 is laminated on the surface of the eighth electrode portion 54 facing the first negative direction X2.

The third wiring portion 35 is made of the same material as the first wiring portion 31. When the fifth layer L5 is viewed in the first negative direction X2, the third wiring portion 35 as a whole extends in a spiral shape with the center of the fifth layer L5 as a substantial center. Specifically, the position of a first end portion 35A of the third wiring portion 35 is on the surface of the via 34 facing the first negative direction X2. Therefore, the first end portion 35A of the third wiring portion 35 is connected to the via 34. The wiring width of the third wiring portion 35 is substantially constant except for the first end portion 35A and a second end portion 35B. The position of the second end portion 35B of the third wiring portion 35 in the direction along the third axis Z is on the third negative direction Z2 side from the center of the fifth layer L5 in the direction along the third axis Z. The position of the second end portion 35B of the third wiring portion 35 in the direction along the second axis Y is on the second negative direction Y2 side from the center of the fifth layer L5 in the direction along the second axis Y. When the third wiring portion 35 is viewed in the first negative direction X2, the third wiring portion 35 extends clockwise from the first end portion 35A toward the second end portion 35B.

In the fifth layer L5, a portion excluding the ninth electrode portion 45, the tenth electrode portion 55, and the third wiring portion 35 is the fifth insulating portion 25. The fifth insulating portion 25 is made of a nonmagnetic insulator of the same material as the first insulating portion 21.

The sixth layer L6 is laminated on the main surface of the fifth layer L5 facing the first negative direction X2. When the sixth layer L6 is viewed in the first negative direction X2, the sixth layer L6 has the same rectangular shape as the first layer L1. The sixth layer L6 includes an eleventh electrode portion 46, a twelfth electrode portion 56, a via 36, and a sixth insulating portion 26.

The eleventh electrode portion 46 is made of the same material as the first electrode portion 41. When the sixth layer L6 is viewed in the first negative direction X2, the eleventh electrode portion 46 has an L shape having the same dimension as the ninth electrode portion 45. When the sixth layer L6 is viewed in the first negative direction X2, the eleventh electrode portion 46 is located at the same position as the ninth electrode portion 45. Therefore, the eleventh electrode portion 46 is laminated on the surface of the ninth electrode portion 45 facing the first negative direction X2.

The twelfth electrode portion 56 is made of the same material as the second electrode portion 51. When the sixth layer L6 is viewed in the first negative direction X2, the twelfth electrode portion 56 has an L shape having the same dimension as the tenth electrode portion 55. When the sixth layer L6 is viewed in the first negative direction X2, the twelfth electrode portion 56 is located at the same position as the tenth electrode portion 55. Therefore, the twelfth electrode portion 56 is laminated on the surface of the tenth electrode portion 55 facing the first negative direction X2.

The via 36 is made of the same material as the first wiring portion 31. The via 36 has a columnar shape extending in the direction along the first axis X. The via 36 is laminated on a surface of the second end portion 35B of the third wiring portion 35 facing the first negative direction X2. Therefore, the via 36 is electrically connected to the second end portion 35B of the third wiring portion 35. The via 36 extends from the second end portion 35B of the third wiring portion 35 in the first negative direction X2.

In the sixth layer L6, a portion excluding the eleventh electrode portion 46, the twelfth electrode portion 56, and the via 36 is the sixth insulating portion 26. The sixth insulating portion 26 is made of a nonmagnetic insulator of the same material as the first insulating portion 21.

The seventh layer L7 is laminated on the main surface of the sixth layer L6 facing the first negative direction X2. When the seventh layer L7 is viewed in the first negative direction X2, the seventh layer L7 has the same rectangular shape as the first layer L1. The seventh layer L7 includes a thirteenth electrode portion 47, a fourteenth electrode portion 57, a fourth wiring portion 37, and a seventh insulating portion 27.

The thirteenth electrode portion 47 is made of the same material as the first electrode portion 41. When the seventh layer L7 is viewed in the first negative direction X2, the thirteenth electrode portion 47 has an L shape having the same dimension as the eleventh electrode portion 46. When the seventh layer L7 is viewed in the first negative direction X2, the thirteenth electrode portion 47 is located at the same position as the eleventh electrode portion 46. Therefore, the thirteenth electrode portion 47 is laminated on the surface of the eleventh electrode portion 46 facing the first negative direction X2.

The fourteenth electrode portion 57 is made of the same material as the second electrode portion 51. When the seventh layer L7 is viewed in the first negative direction X2, the fourteenth electrode portion 57 has an L shape having the same dimension as the twelfth electrode portion 56. When the seventh layer L7 is viewed in the first negative direction X2, the fourteenth electrode portion 57 is located at the same position as the twelfth electrode portion 56. Therefore, the fourteenth electrode portion 57 is laminated on the surface of the twelfth electrode portion 56 facing the first negative direction X2.

The fourth wiring portion 37 is made of the same material as the first wiring portion 31. When the seventh layer L7 is viewed in the first negative direction X2, the fourth wiring portion 37 extends as a whole in a spiral shape with the center of the seventh layer L7 as a substantial center. Specifically, the position of a first end portion 37A of the fourth wiring portion 37 is on the surface of the via 36 facing the first negative direction X2. Therefore, the first end portion 37A of the fourth wiring portion 37 is connected to the via 36. The wiring width of the fourth wiring portion 37 is substantially constant except for the first end portion 37A and a second end portion 37B. The position of the second end portion 37B of the fourth wiring portion 37 in the direction along the third axis Z is on the third positive direction Z1 side from the center of the seventh layer L7 in the direction along the third axis Z. The position of the second end portion 37B of the fourth wiring portion 37 in the direction along the second axis Y is on the second negative direction Y2 side from the center of the seventh layer L7 in the direction along the second axis Y. Furthermore, the position of the second end portion 37B of the fourth wiring portion 37 in the direction along the second axis Y is on the second negative direction Y2 side from the position of the first end portion 37A in the direction along the second axis Y. When the fourth wiring portion 37 is viewed in the first negative direction X2, the fourth wiring portion 37 extends clockwise from the first end portion 37A toward the second end portion 37B. The fourth wiring portion 37 is rotationally symmetric with the second wiring portion 33 with an axis in a direction along the third axis Z passing through the center in the extending direction of the inductor wiring 30 as a rotation axis.

In the seventh layer L7, a portion excluding the thirteenth electrode portion 47, the fourteenth electrode portion 57, and the fourth wiring portion 37 is the seventh insulating portion 27. The seventh insulating portion 27 is made of a nonmagnetic insulator of the same material as the first insulating portion 21.

The eighth layer L8 is laminated on the main surface of the seventh layer L7 facing the first negative direction X2. When the eighth layer L8 is viewed in the first negative direction X2, the eighth layer L8 has the same rectangular shape as the first layer L1. The eighth layer L8 includes a fifteenth electrode portion 48, a sixteenth electrode portion 58, a via 38, and an eighth insulating portion 28.

The fifteenth electrode portion 48 is made of the same material as the first electrode portion 41. When the eighth layer L8 is viewed in the first negative direction X2, the fifteenth electrode portion 48 has an L shape having the same dimension as the thirteenth electrode portion 47. When the eighth layer L8 is viewed in the first negative direction X2, the fifteenth electrode portion 48 is located at the same position as the thirteenth electrode portion 47. Therefore, the fifteenth electrode portion 48 is laminated on the surface of the thirteenth electrode portion 47 facing the first negative direction X2.

The sixteenth electrode portion 58 is made of the same material as the second electrode portion 51. When the eighth layer L8 is viewed in the first negative direction X2, the sixteenth electrode portion 58 has an L shape having the same dimension as the fourteenth electrode portion 57. When the eighth layer L8 is viewed in the first negative direction X2, the sixteenth electrode portion 58 is located at the same position as the fourteenth electrode portion 57. Therefore, the sixteenth electrode portion 58 is laminated on the surface of the fourteenth electrode portion 57 facing the first negative direction X2.

The via 38 is made of the same material as the first wiring portion 31. The via 38 has a columnar shape extending in the direction along the first axis X. The via 38 is laminated on a surface of the second end portion 37B of the fourth wiring portion 37 facing the first negative direction X2. Therefore, the via 38 is electrically connected to the second end portion 37B of the fourth wiring portion 37. The via 38 extends from the second end portion 37B of the fourth wiring portion 37 in the first negative direction X2.

In the eighth layer L8, a portion excluding the fifteenth electrode portion 48, the sixteenth electrode portion 58, and the via 38 is the eighth insulating portion 28. The eighth insulating portion 28 is made of a nonmagnetic insulator of the same material as the first insulating portion 21.

The ninth layer L9 is laminated on the main surface of the eighth layer L8 facing the first negative direction X2. When the ninth layer L9 is viewed in the first negative direction X2, the ninth layer L9 has the same rectangular shape as the first layer L1. The ninth layer L9 includes a seventeenth electrode portion 49, an eighteenth electrode portion 59, a fifth wiring portion 39, and a ninth insulating portion 29.

The seventeenth electrode portion 49 is made of the same material as the first electrode portion 41. When the ninth layer L9 is viewed in the first negative direction X2, the seventeenth electrode portion 49 has an L shape having the same dimension as the fifteenth electrode portion 48. When the ninth layer L9 is viewed in the first negative direction X2, the seventeenth electrode portion 49 is located at the same position as the fifteenth electrode portion 48. Therefore, the seventeenth electrode portion 49 is laminated on the surface of the fifteenth electrode portion 48 facing the first negative direction X2.

The eighteenth electrode portion 59 is made of the same material as the second electrode portion 51. When the ninth layer L9 is viewed in the first negative direction X2, the eighteenth electrode portion 59 has an L shape having the same dimension as the sixteenth electrode portion 58. When the ninth layer L9 is viewed in the first negative direction X2, the eighteenth electrode portion 59 is located at the same position as the sixteenth electrode portion 58. Therefore, the eighteenth electrode portion 59 is laminated on the surface of the sixteenth electrode portion 58 facing the first negative direction X2.

The fifth wiring portion 39 is made of the same material as the first wiring portion 31. When the ninth layer L9 is viewed in the first negative direction X2, the fifth wiring portion 39 extends as a whole in a spiral shape with the center of the ninth layer L9 as a substantial center. Specifically, the position of a first end portion 39A of the fifth wiring portion 39 is on the surface of the via 38 facing the first negative direction X2. Therefore, the first end portion 39A of the fifth wiring portion 39 is connected to the via 38. The wiring width of the fifth wiring portion 39 is substantially constant except for the first end portion 39A. A second end portion 39B of the fifth wiring portion 39 is connected to an end portion of the eighteenth electrode portion 59 on the third positive direction Z1 side in the direction along the third axis Z. When the fifth wiring portion 39 is viewed in the first negative direction X2, the fifth wiring portion 39 extends clockwise from the first end portion 39A toward the second end portion 39B. The second end portion 39B of the fifth wiring portion 39 is a second end portion of the inductor wiring 30. The fifth wiring portion 39 is rotationally symmetric with the first wiring portion 31 with an axis in a direction along the third axis Z passing through the center in the extending direction of the inductor wiring 30 as a rotation axis.

In the ninth layer L9, a portion excluding the seventeenth electrode portion 49, the eighteenth electrode portion 59, and the fifth wiring portion 39 is the ninth insulating portion 29. The ninth insulating portion 29 is made of an insulator of the same material as that of the first insulating portion 21.

The element body 11 further includes a tenth layer L10 to a thirteenth layer L13.

The tenth layer L10 is laminated on the main surface of the first layer L1 facing the first positive direction X1. When the tenth layer L10 is viewed in the first negative direction X2, the tenth layer L10 has the same rectangular shape as the first layer L1. The tenth layer L10 includes a first covering layer 61 and a tenth insulating portion 66.

The first covering layer 61 is made of an insulator having optical properties different from those of the first insulating portion 21. Specifically, the first covering layer 61 contains a coloring agent containing cobalt in addition to the material of the first insulating portion 21. Therefore, the first covering layer 61 is blue under visible light.

The first covering layer 61 spreads in parallel to the first main surface 11A. In the present embodiment, the first main surface 11A is a first surface. When the tenth layer L10 is viewed in the first negative direction X2, the first covering layer 61 has a quadrangular shape. When the tenth layer L10 is viewed in the first negative direction X2, the entire outer edge of the first covering layer 61 is located inside the outer edge of the first layer L1.

In the tenth layer L10, a portion excluding the first covering layer 61 is the tenth insulating portion 66. The tenth insulating portion 66 is made of an insulator of the same material as that of the first insulating portion 21. When the tenth layer L10 is viewed in the first negative direction X2, the tenth insulating portion 66 surrounds the outer edge of the first covering layer 61. That is, the tenth insulating portion 66 has a quadrangular frame shape. The eleventh layer L11 is laminated on the main surface of the tenth layer L10 facing the first positive direction X1. When the eleventh layer L11 is viewed in the first negative direction X2, the eleventh layer L11 has the same rectangular shape as the first layer L1. The entire eleventh layer L11 is formed of the eleventh insulating portion 67. The eleventh insulating portion 67 is made of an insulator of the same material as that of the first insulating portion 21.

The twelfth layer L12 is laminated on the main surface of the ninth layer L9 facing the first negative direction X2. When the twelfth layer L12 is viewed in the first positive direction X1, the twelfth layer L12 has the same rectangular shape as the first layer L1. The twelfth layer L12 includes a second covering layer 62 and a twelfth insulating portion 68.

The second covering layer 62 is made of an insulator having optical properties different from those of the first insulating portion 21. Specifically, similarly to the first covering layer 61, the second covering layer 62 contains a coloring agent containing cobalt in addition to the material of the first insulating portion 21. Therefore, the second covering layer 62 is blue under visible light.

The second covering layer 62 spreads in parallel to the second main surface 11B. In the present embodiment, the second main surface 11B is a second surface. When the twelfth layer L12 is viewed in the first positive direction X1, the second covering layer 62 has a quadrangular shape. When the twelfth layer L12 is viewed in the first positive direction X1, the entire outer edge of the second covering layer 62 is located inside the outer edge of the second layer L2.

In the twelfth layer L12, a portion excluding the second covering layer 62 is the twelfth insulating portion 68. The twelfth insulating portion 68 is made of an insulator of the same material as that of the first insulating portion 21. When the twelfth layer L12 is viewed in the first positive direction X1, the twelfth insulating portion 68 surrounds the outer edge of the first covering layer 61. That is, the tenth insulating portion 66 has a quadrangular frame shape.

The thirteenth layer L13 is laminated on the main surface of the twelfth layer L12 facing the first negative direction X2. When the thirteenth layer L13 is viewed in the first positive direction X1, the thirteenth layer L13 has the same rectangular shape as the first layer L1. The entire thirteenth layer L13 is formed of the thirteenth insulating portion 69. The thirteenth insulating portion 69 is made of an insulator of the same material as that of the first insulating portion 21.

As described above, the element body 11 includes the first insulating portion 21 to the thirteenth insulating portion 69. That is, the element body 11 includes a plurality of insulating portions laminated in the direction along the first axis X. The first insulating portion 21 to the ninth insulating portion 29 and the tenth insulating portion 66 to the thirteenth insulating portion 69 described above are sintered bodies. Therefore, the plurality of insulating portions are integrated. Therefore, there is no physical boundary between them. Hereinafter, in a case where it is not necessary to distinguish these, they are collectively referred to as a main body 20. Note that the first insulating portion 21 to the ninth insulating portion 29 and the tenth insulating portion 66 to the thirteenth insulating portion 69 may not be integrated. That is, there may be a physical boundary between them.

In addition, the first wiring portion 31, the second wiring portion 33, the third wiring portion 35, the fourth wiring portion 37, the fifth wiring portion 39, the via 32, the via 34, the via 36, and the via 38 are integrated. Therefore, there is no physical boundary between them. Hereinafter, in a case where it is not necessary to distinguish them, they are collectively referred to as the inductor wiring 30. The inductor wiring 30 is spirally wound as a whole. The central axis, when the inductor wiring 30 is wound, is an axis extending in the direction along the first axis X. Note that the first wiring portion 31, the second wiring portion 33, the third wiring portion 35, the fourth wiring portion 37, the fifth wiring portion 39, the via 32, the via 34, the via 36, and the via 38 may not be integrated. That is, there may be a physical boundary between them.

Furthermore, the first electrode portion 41, the third electrode portion 42, the fifth electrode portion 43, the seventh electrode portion 44, the ninth electrode portion 45, the eleventh electrode portion 46, the thirteenth electrode portion 47, the fifteenth electrode portion 48, and the seventeenth electrode portion 49 described above are integrated. Then, these are combined to form the first electrode 40.

Similarly, the second electrode portion 51, the fourth electrode portion 52, the sixth electrode portion 53, the eighth electrode portion 54, the tenth electrode portion 55, the twelfth electrode portion 56, the fourteenth electrode portion 57, the sixteenth electrode portion 58, and the eighteenth electrode portion 59 described above are integrated. Then, these are combined to form the second electrode 50.

In the present embodiment, the main body 20, the first electrode 40, the second electrode 50, the first covering layer 61, and the second covering layer 62 constitute the element body 11 of the inductor component 10. The inductor wiring 30 extends inside the element body 11. Note that the inductor wiring 30, the first electrode 40, and the second electrode 50 may be integrated. That is, there may be no physical boundary between the inductor wiring 30 and the first electrode 40 or between the inductor wiring 30 and the second electrode 50.

As a result of laminating the first layer L1 to the thirteenth layer L13, the element body 11 has a rectangular shape as a whole as illustrated in FIG. 1. As illustrated in FIG. 3, the first electrode 40 is exposed to the outside of the element body 11 in a region from the first end surface 11C to the bottom surface 11E. In addition, the second electrode 50 is exposed to the outside of the element body 11 in a region from the second end surface 11D to the bottom surface 11E.

As illustrated in FIG. 1, the inductor component 10 includes a first covering electrode 71 and a second covering electrode 72. The first covering electrode 71 covers a surface of the first electrode 40 exposed to the outside from the element body 11. Although not illustrated, the first covering electrode 71 has a two-layer structure of nickel plating and tin plating.

The second covering electrode 72 covers a surface of the second electrode 50 exposed to the outside from the element body 11. Although not illustrated, the second covering electrode 72 has a two-layer structure of nickel plating and tin plating. In FIGS. 2 and 3, illustration of the first covering electrode 71 and the second covering electrode 72 is omitted.

(Circling Path of Inductor Wiring)

As illustrated in FIG. 3, the inductor wiring 30 as a whole extends in a spiral shape with the center axis extending in a direction along the first axis X as a winding center. As illustrated in FIG. 2, each of the first wiring portion 31, the second wiring portion 33, the third wiring portion 35, the fourth wiring portion 37, and the fifth wiring portion 39 extends in parallel to the first main surface 11A.

Here, as illustrated in FIG. 3, when the inductor wiring 30 is viewed in the first negative direction X2, the first wiring portion 31, the second wiring portion 33, the third wiring portion 35, the fourth wiring portion 37, and the fifth wiring portion 39 have a circling path CR. When the inductor wiring 30 is viewed in the first negative direction X2, the circling path CR is wound in an annular shape one turn. In other words, the circling path CR is a portion overlapping at least two layers of the inductor wiring 30 when viewed in the first negative direction X2 through the inductor component 10. Therefore, a part of the first wiring portion 31 of the first layer L1 including the first end portion 31A is not included in the circling path CR. Further, a part of the fifth wiring portion 39 of the ninth layer L9 including the second end portion 39B is not included in the circling path CR.

The circling path CR includes an upper side portion P1, a lower side portion P2, a first side portion P3, a second side portion P4, a first oblique side portion P5, and a second oblique side portion P6.

The upper side portion P1 extends parallel to the second axis Y. The upper side portion P1 includes a portion of the inductor wiring 30 closest to the top surface 11F. That is, when the inductor wiring 30 is viewed in the first negative direction X2, the upper side portion P1 is a portion including a portion closest to the top surface 11F in a portion where the first wiring portion 31 and the second wiring portion 33 overlap each other and extending parallel to the second axis Y.

The lower side portion P2 extends parallel to the second axis Y. The lower side portion P2 includes a portion of the inductor wiring 30 closest to the bottom surface 11E. That is, when the inductor wiring 30 is viewed in the first negative direction X2, the lower side portion P2 is a portion including a portion closest to the bottom surface 11E in a portion where the first wiring portion 31 and the second wiring portion 33 overlap each other and extending parallel to the second axis Y. The dimension of the lower side portion P2 in the direction along the second axis Y is smaller than the dimension of the upper side portion P1 in the direction along the second axis Y. An end of the lower side portion P2 on the second positive direction Y1 side is located on the second negative direction Y2 side with respect to an end of the upper side portion P1 on the second positive direction Y1 side. An end of the lower side portion P2 on the second negative direction Y2 side is located on the second positive direction Y1 side with respect to an end of the upper side portion P1 on the second negative direction Y2 side.

The first side portion P3 extends parallel to the third axis Z. When the inductor wiring 30 is viewed in the first negative direction X2, an end of the first side portion P3 on the third positive direction Z1 side coincides with the position of an end of the upper side portion P1 on the second positive direction Y1 side. An end of the first side portion P3 on the third negative direction Z2 side is located on the second positive direction Y1 side and the third positive direction Z1 side with respect to the end of the lower side portion P2 on the second positive direction Y1 side.

The second side portion P4 extends parallel to the third axis Z. When the inductor wiring 30 is viewed in the first negative direction X2, an end of the second side portion P4 on the third positive direction Z1 side coincides with a position of an end of the upper side portion P1 on the second negative direction Y2 side. An end of the second side portion P4 on the third negative direction Z2 side is located on the second negative direction Y2 side and the third positive direction Z1 side with respect to an end of the lower side portion P2 on the second negative direction Y2 side.

The first oblique side portion P5 extends linearly so as to be oblique to both the second axis Y and the third axis Z. Specifically, the first oblique side portion P5 extends obliquely so as to be located on the third negative direction Z2 side toward the second negative direction Y2 side. An end of the first oblique side portion P5 on the third positive direction Z1 side coincides with the position of the end of the first side portion P3 on the third negative direction Z2 side. An end of the first oblique side portion P5 on the third negative direction Z2 side coincides with the position of the end of the lower side portion P2 on the second positive direction Y1 side.

The second oblique side portion P6 extends linearly so as to be oblique to both the second axis Y and the third axis Z. Specifically, the second oblique side portion P6 extends obliquely so as to be located on the third negative direction Z2 side toward the second positive direction Y1 side. An end of the second oblique side portion P6 on the third positive direction Z1 side coincides with a position of an end of the second side portion P4 on the third negative direction Z2 side. An end of the second oblique side portion P6 on the third negative direction Z2 side coincides with a position of an end of the lower side portion P2 on the second negative direction Y2 side.

As described above, when the inductor wiring 30 is viewed in the third negative direction Z2, the circling path CR circles clockwise in the order of the upper side portion P1, the second side portion P4, the second oblique side portion P6, the lower side portion P2, the first oblique side portion P5, and the first side portion P3.

(First Covering Layer and Second Covering Layer)

As illustrated in FIG. 2, the first covering layer 61 is located on the first main surface 11A side with respect to the end of the circling path CR on the first main surface 11A side. Specifically, the end of the circling path CR on the first positive direction X1 side is a surface of the first wiring portion 31 facing the first positive direction X1. The first covering layer 61 is laminated on a surface of the first layer L1 facing the first positive direction X1 where the first wiring portion 31 is present. Therefore, the first covering layer 61 is located on the first positive direction X1 side with respect to the first wiring portion 31.

As illustrated in FIG. 3, when the inductor component 10 is viewed in the first negative direction X2, the first covering layer 61 overlaps the entire circling path CR. When the inductor component 10 is viewed in the first negative direction X2, the range surrounded by the outer edge of the first covering layer 61 is smaller than the range surrounded by the outer edge of the main body 20. Therefore, the entire surface of the first covering layer 61 facing the first positive direction X1 is covered with the eleventh insulating portion 67, and the first covering layer 61 is not exposed to the outside from the first main surface 11A. Further, when the inductor component 10 is viewed in the first negative direction X2, the entire outer edge of the first covering layer 61 is located inside the outer edge of the element body 11. That is, since the first covering layer 61 is not exposed from the first end surface 11C, the second end surface 11D, the bottom surface 11E, and the top surface 11F, the entire first covering layer 61 is located inside the main body 20.

Here, the light transmittance of the first covering layer 61 at a specific wavelength is smaller than the light transmittance of the main body 20 at a specific wavelength. In the present embodiment, the specific wavelength is a wavelength visually recognized in blue, that is, any wavelength within the range of 430 to 490 nm. Specifically, the main body 20 is colorless and transparent under visible light. On the other hand, under visible light, the first covering layer 61 is opaque blue.

As illustrated in FIG. 2, the second covering layer 62 is located on the second main surface 11B side with respect to the end of the circling path CR on the second main surface 11B side. Specifically, the end of the circling path CR on the first negative direction X2 side is a surface of the fifth wiring portion 39 facing the first negative direction X2. The second covering layer 62 is laminated on the surface of the ninth layer L9 facing the first negative direction X2 where the fifth wiring portion 39 is present. Therefore, the second covering layer 62 is located on the first negative direction X2 side with respect to the fifth wiring portion 39.

Similarly to the first covering layer 61, when the inductor component 10 is viewed in the first positive direction X1, the second covering layer 62 overlaps the entire circling path CR. When the inductor component 10 is viewed in the first positive direction X1, the range surrounded by the outer edge of the second covering layer 62 is smaller than the range surrounded by the outer edge of the main body 20. Therefore, the entire surface of the second covering layer 62 facing the first negative direction X2 is covered with the thirteenth insulating portion 69, and the second covering layer 62 is not exposed to the outside from the second main surface 11B. Furthermore, when the inductor component 10 is viewed in the first positive direction X1, the entire outer edge of the second covering layer 62 is located inside the outer edge of the element body 11. That is, since the second covering layer 62 is not exposed from the first end surface 11C, the second end surface 11D, the bottom surface 11E, and the top surface 11F, the entire second covering layer 62 is located inside the main body 20.

Similarly to the first covering layer 61, the light transmittance of the second covering layer 62 at a specific wavelength is smaller than the light transmittance of the main body 20 at a specific wavelength. In the present embodiment, the specific wavelength is a wavelength visually recognized in blue, that is, any wavelength within the range of 430 to 490 nm. Specifically, under visible light, the second covering layer 62 is opaque blue.

### Effects of Embodiment

According to the above embodiment, the following effects are obtained. Note that effects common to the first covering layer 61 and the second covering layer 62 will be described with the first covering layer 61 as a representative, and the description of the second covering layer 62 will be omitted.
(1) According to the above embodiment, when the inductor component 10 is viewed in the first negative direction X2, a part of the outer edge of the first covering layer 61 does not coincide with the outer edge of the main body 20. Therefore, it is possible to reduce the probability that the inductor component 10 comes into direct contact with another object so that a force is applied in parallel to the contact surface between the first covering layer 61 and the main body 20. Therefore, it is possible to suppress peeling of the first covering layer 61 from the main body 20 with the outer edge of the first covering layer 61 as a starting point when the inductor component 10 is viewed in the first negative direction X2.
(2) According to the above embodiment, the first covering layer 61 is not exposed to the outside from the first main surface 11A. That is, the first covering layer 61 is sandwiched by the main body 20 from both sides in the direction along the first axis X. Therefore, the first covering layer 61 is not peeled off from the main body 20 as long as a part of the main body 20 does not fall off.
(3) According to the above embodiment, the entire first covering layer 61 is located inside the main body 20. That is, the interface between the first covering layer 61 and the main body 20 is not exposed to the outside. Therefore, impact from the outside of the inductor component 10 is less likely to be directly applied to the interface between the first covering layer 61 and the main body 20.
(4) According to the above embodiment, the main body 20 includes the plurality of insulating portions. The plurality of insulating portions are laminated in the direction along the first axis X. The first covering layer 61 spreads in a direction orthogonal to the first axis X. That is, it is possible to manufacture the main body 20 by laminating the plurality of insulating portions and the first covering layer 61 in the direction along the first axis X. Therefore, it is possible to realize a structure in which the inductor component 10 can be manufactured relatively easily.
(5) According to the above embodiment, the light transmittance of the first covering layer 61 at a specific wavelength is smaller than the light transmittance of the main body 20 at the same wavelength. When the inductor component 10 is viewed in the first negative direction X2, the first covering layer 61 overlaps the entire circling path CR. Therefore, when the first main surface 11A of the element body 11 is observed, the entire circling path CR of the inductor wiring 30 is covered with the first covering layer 61. That is, when the first main surface 11A is optically observed, the first covering layer 61 can be used as an optical cover for the circling path CR. Therefore, it is possible to prevent the circling path CR from becoming an obstacle when the first main surface 11A is optically observed.
(6) According to the above embodiment, since the plurality of insulating portions are sintered bodies, it is difficult to visually recognize the interface between the insulating portions. Therefore, it is easy to find a crack or the like in the main body 20 when the main body 20 is optically observed.
(7) As in the above embodiment, all of the main body 20, the first covering layer 61, and the second covering layer 62 are preferably sintered bodies. In this case, the element body 11 can be collectively formed by forming each layer by a green sheet, printing application, or the like and then sintering. When all of the main body 20, the first covering layer 61, and the second covering layer 62 are sintered bodies, the close contact force between these layers is improved.

### Other Embodiments

The above embodiment can be modified as below and be implemented. The above embodiment and the following modifications can be implemented in combination within a range not technically contradictory. The common points between the first covering layer 61 and the second covering layer 62 will be described with the first covering layer 61 as a representative, and thus the description of the second covering layer 62 will be omitted.

That is, the thicknesses of the first layer L1 to the thirteenth layer L13, that is, the dimensions in the direction along the first axis X are not necessarily the same. All the thicknesses may be different from each other, or the thicknesses of some layers may be different from the thicknesses of other layers.

The element body 11 may be a rectangular parallelepiped that is long in the direction along the first axis X or a rectangular parallelepiped that is long in the direction along the third axis Z. Further, the element body 11 may be a rectangular parallelepiped having the same dimension in the direction along the first axis X, the same dimension in the direction along the second axis Y, and the same dimension in the direction along the third axis Z. For example, with respect to the dimension in the direction along each axis of the element body 11, the dimension in the direction along the first axis X may be equal to the dimension in the direction along the third axis Z, and the dimension in the direction along the second axis Y may be larger than the dimension in the direction along the first axis X. For example, with respect to the dimension in the direction along each axis of the element body 11, the dimension in the direction along the second axis Y may be larger than the dimension in the direction along the third axis Z, and the dimension in the direction along the third axis Z may be larger than the dimension in the direction along the first axis X. For example, the dimension in the direction along the second axis Y may be larger than the dimension in the direction along the first axis X, and the dimension in the direction along the first axis X may be larger than the dimension in the direction along the third axis Z.

The material of the main body 20 is not limited to the example of the above embodiment, and may be any material having an insulating property. For example, the material of the main body 20 may be a magnetic insulator. Further, a part of the main body 20 may be an insulator different from other portions. In addition, for example, the material of the main body 20 may be made of an organic material such as an epoxy resin instead of the sintered body. Furthermore, for example, the color of the main body 20 may not be transparent or may be transparent white.

The configuration of the main body 20 is not limited to the example of the above embodiment. The plurality of insulating portions may be laminated in the direction along the third axis Z. Further, the main body 20 may be configured by one insulating portion.

The shape of the first electrode 40 is not limited to the example of the above embodiment. For example, the first electrode 40 may be connected to the first end of the inductor wiring 30, and at least a part thereof may be exposed to the outside of the element body 11. For example, the first electrode 40 may be omitted, and the first end of the inductor wiring 30 may be directly connected to the first covering electrode 71. The same applies to the second electrode 50.

The structure of the first covering electrode 71 is not limited to the example of the above embodiment. For example, the first covering electrode 71 may be made only of tin plating. The first covering electrode 71 can be omitted. In this case, for example, the first electrode 40 may be fixed to a substrate or the like by soldering. The same applies to the second covering electrode 72.

(First Covering Layer and Second Covering Layer)

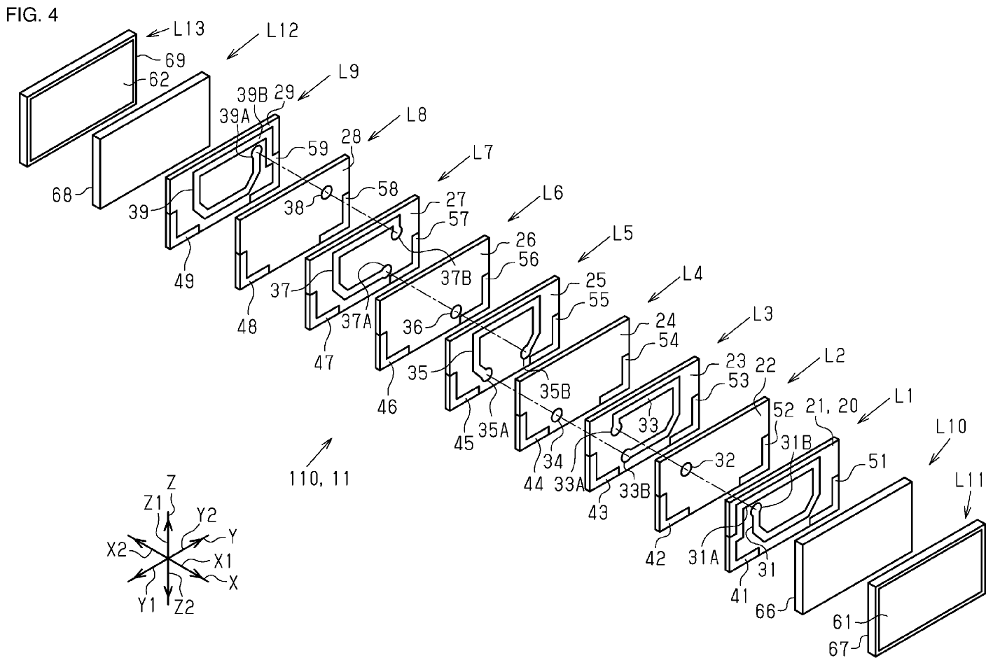

The position of the first covering layer 61 in the direction along the first axis X and the position of the second covering layer 62 in the direction along the first axis X are not limited to the example of the above embodiment. For example, in an inductor component 110 of a modification illustrated in FIG. 4, the position of the first covering layer 61 and the position of the second covering layer 62 are different from those of the inductor component 10 of the above embodiment. Specifically, in the inductor component 110, the first covering layer 61 is present in the eleventh layer L11. Therefore, a part of the first main surface 11A is the surface of the first covering layer 61. As a result, it is easier to visually recognize the first covering layer 61 from the outside of the inductor component 10 than when the entire first covering layer 61 is present inside the main body 20.

The second covering layer 62 is present in the thirteenth layer L13. Similarly, a part of the second main surface 11B is the surface of the second covering layer 62. As a result, it is easier to visually recognize the second covering layer 62 from the outside of the inductor component 10 than when the entire second covering layer 62 is present inside the main body 20.

When the inductor component 110 of the modification illustrated in FIG. 4 is manufactured, for example, the following may be performed. First, when the eleventh layer L11 or the thirteenth layer L13 is formed, a through hole or a recess is formed in a central portion of the eleventh insulating portion 67 or the thirteenth insulating portion 69 to be the main body 20 by a known method such as photolithography, laser, or machining. Next, the material of the first covering layer 61 or the second covering layer 62 may be applied, filled, or the like to the through hole or the recess.

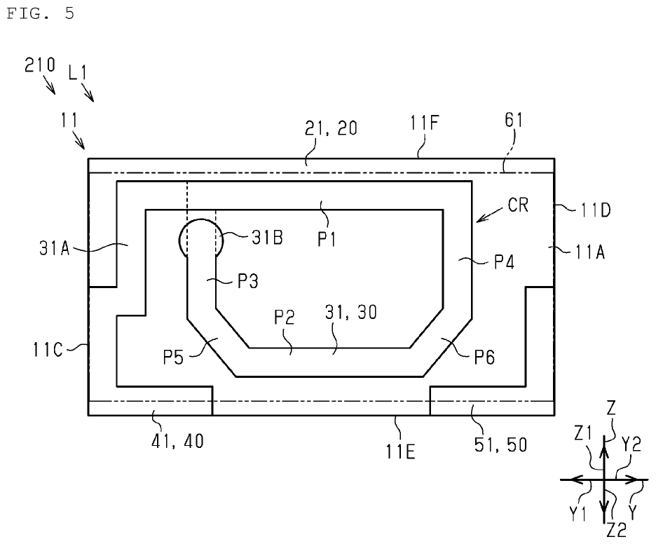

The shape of the first covering layer 61 is not limited to the example of the above embodiment. In an inductor component 210 of a modification illustrated in FIG. 5, the size of the first covering layer 61 is different from that of the inductor component 10 of the above embodiment. Specifically, in the inductor component 210, the dimension of the first covering layer 61 in the direction along the second axis Y coincides with the dimension of the element body 11 in the direction along the second axis Y. Therefore, when the inductor component 210 is viewed in the first negative direction X2, a part of the outer edge of the first covering layer 61 coincides with the outer edge of the first main surface 11A. Such an inductor component 210 can be manufactured, for example, as follows. First, a mother sheet in which the plurality of inductor components 210 are arranged in the direction along the second axis Y is formed. Thereafter, the mother sheet is cut in the direction along the third axis Z to singulate the inductor components 210. In this case, when the sheet is formed, a plurality of first covering layers 61 can be formed so as to be integrated in the direction along the second axis Y. Therefore, the manufacturing process can be made more efficient than a case where a separate first covering layer 61 is formed.

Further, for example, in the inductor component 110 of the modification illustrated in FIG. 4, the eleventh insulating portion 67 may be omitted. As a result, the eleventh layer L11 may include only the first covering layer 61. In this case, the entire first main surface 11A is the first covering layer 61. Even in this case, the first covering layer 61 is located on the first main surface 11A side with respect to the end of the circling path CR on the first main surface 11A side. In this regard, as for the second covering layer 62, similarly, the entire second main surface 11B may be the second covering layer 62. In these cases, the element body 11 may have at least one flat surface as the outer surface of the element body 11 if the element body 11 does not have a rectangular parallelepiped shape.

As described above, in the inductor component 110 of the modification illustrated in FIG. 4, when the configuration in which the eleventh insulating portion 67 is omitted is manufactured, for example, the following configuration may be adopted. First, after the tenth insulating portion 66 of the tenth layer L10 is formed, a material to be the first covering layer 61 is applied onto these main surfaces. Next, the first covering layer 61 may be formed inside the outer edge of the main body 20 by patterning or masking.

The shapes of the first covering layer 61 and the second covering layer 62 in plan view are not limited to the above embodiment. For example, when the first covering layer 61 is viewed in the first negative direction X2, the first covering layer 61 may have a circular shape.

The position and size of the second covering layer 62 may be different from those of the first covering layer 61. For example, in the inductor component 10 of the above embodiment, the first covering layer 61 may be located in the eleventh layer L11. In the case of this modification, of the first covering layer 61 and the second covering layer 62, only the first covering layer 61 is exposed to the outside of the main body 20. Therefore, the optical properties, for example, the density of blue is visually recognized differently between the first main surface 11A and the second main surface 11B of the main body 20. Accordingly, the first main surface 11A and the second main surface 11B can be distinguished from each other when viewed from the outside of the inductor component 10.

The shape of the first covering layer 61 in plan view may be different from the shape of the second covering layer 62 in plan view. For example, the shape of the second covering layer 62 when the second covering layer 62 is viewed in the first positive direction X1 may be different from the shape of the first covering layer 61 when the first covering layer 61 is viewed in the first negative direction X2. In this case, the first main surface 11A and the second main surface 11B of the main body 20 are visually recognized to have different shapes in the blue range. Accordingly, the first main surface 11A and the second main surface 11B can be distinguished from each other when viewed from the outside of the inductor component 10.

The light transmittance of the first covering layer 61 at a specific wavelength may be equal to or higher than the light transmittance of the main body 20 at the same wavelength. When the element body 11 is viewed in the first positive direction X1, the element body 11 may be seen to be different from the case where the first covering layer 61 is not provided. That is, the first covering layer 61 may have optical properties different from those of the main body 20. In addition, the specific wavelength is not limited to the wavelength in the visible light region, and may be a wavelength in the invisible light region. Furthermore, the optical properties may include at least one property of brightness, saturation, and chromaticity. For example, the first covering layer 61 is not limited to one that is blue under visible light, and may be green, gray, or black.

The color of the first covering layer 61 may be different from the color of the second covering layer 62. For example, the first covering layer 61 may be green under visible light and the second covering layer 62 may be blue under visible light. In this case, the first main surface 11A and the second main surface 11B of the main body 20 are visually recognized in different colors. Accordingly, the first main surface 11A and the second main surface 11B can be distinguished from each other when viewed from the outside of the inductor component 10.

The central axis in the circling path CR of the inductor wiring 30 may extend along the third axis Z. Even in this case, when the inductor component 10 is viewed in the first negative direction X2, the first covering layer 61 may overlap the entire circling path CR of the inductor wiring 30.

The circling path CR of the inductor wiring 30 may be wound more than one turn. For example, each wiring portion may be spirally wound more than one turn, and the circling path CR may be wound more than one turn. Note that the circling path CR does not need to be wound one or more turns in each layer. The circling path CR only needs to be wound one turn in the total of all the layers, and the circling path CR in each layer may be wound less than one turn.

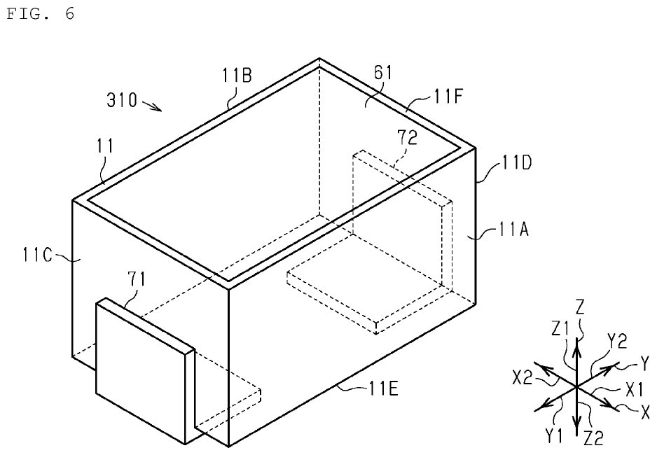

The first surface is not limited to the first main surface 11A. In an inductor component 310 of a modification illustrated in FIG. 6, the first covering layer 61 is a part of the top surface 11F. Although not illustrated, the first covering layer 61 overlaps the entire circling path CR of the inductor wiring 30 when the inductor component 10 is viewed in the third negative direction Z2. That is, the first surface is the top surface 11F.

The technical idea that can be grasped from the above embodiment and modifications will be described.
<1> An inductor component including an element body; and an inductor wiring extending inside the element body. One flat surface of outer surfaces of the element body is defined as a main surface, and when viewed in a direction perpendicular to the main surface, the inductor wiring has a circling path wound one or more turns. The element body includes a main body having an insulating property and a covering layer having optical properties different from optical properties of the main body and parallel to a first surface that is one flat surface of the outer surfaces of the element body. The covering layer is located on a first surface side with respect to an end of the circling path on a first surface side. Also, when viewed in a direction perpendicular to the first surface, the covering layer overlaps the entire circling path, and a range surrounded by an outer edge of the covering layer is smaller than a range surrounded by an outer edge of the main body.
<2> The inductor component according to <1>, in which the covering layer is not exposed to an outside from the first surface.
<3> The inductor component according to <2>, in which the entire covering layer is located inside the main body.
<4> The inductor component according to <1>, in which at least a part of the first surface is a surface of the covering layer.
<5> The inductor component according to <4>, in which the entire first surface is the surface of the covering layer.
<6> The inductor component according to any one of <1> to <5>, in which when viewed in the direction perpendicular to the first surface, a part of the outer edge of the covering layer coincides with the outer edge of the main body.
<7> The inductor component according to any one of <1> to <6>, in which when the covering layer is defined as a first covering layer, and a surface parallel to the first surface among the six outer surfaces is defined as a second surface, the element body further includes a second covering layer parallel to the first covering layer, and the second covering layer is located on a second surface side with respect to an end of the circling path on a second surface side. Also, when viewed in the direction perpendicular to the first surface, the second covering layer overlaps the entire circling path, and a range surrounded by an outer edge of the second covering layer is smaller than a range surrounded by an outer edge of the main body.
<8> The inductor component according to <7>, in which the entire second covering layer is located inside the main body.
<9> The inductor component according to <7>, in which the entire second surface is a surface of the second covering layer.
<10> The inductor component according to any one of <1> to <9>, in which the main body includes a plurality of insulating portions, the plurality of insulating portions are laminated in the direction perpendicular to the main surface, and the first surface is the main surface.
<11> The inductor component according to any one of <1> to <10>, in which a light transmittance of the covering layer at a specific wavelength is smaller than a light transmittance of the main body at the specific wavelength.
<12> The inductor component according to any one of <1> to <11>, in which the main body includes a plurality of insulating portions, and the plurality of insulating portions are sintered bodies.

What is claimed is:

1. An inductor component comprising:
an element body; and
an inductor wiring extending inside the element body,
wherein
one flat surface of outer surfaces of the element body is defined as a main surface,
when viewed in a direction perpendicular to the main surface, the inductor wiring has a circling path wound one or more turns,
the element body includes a main body having an insulating property and a covering layer having optical properties different from optical properties of the main body and being parallel to a first surface that is one flat surface of the outer surfaces of the element body,
the covering layer is on a first surface side with respect to an end of the circling path on a first surface side, and
when viewed in a direction perpendicular to the first surface, the covering layer overlaps the entire circling path, and a range surrounded by an outer edge of the covering layer is smaller than a range surrounded by an outer edge of the main body.

2. The inductor component according to claim 1, wherein
the covering layer is not exposed to an outside from the first surface.

3. The inductor component according to claim 2, wherein
the entire covering layer is inside the main body.

4. The inductor component according to claim 1, wherein
at least a part of the first surface is a surface of the covering layer.

5. The inductor component according to claim 4, wherein
the entire first surface is the surface of the covering layer.

6. The inductor component according to claim 1, wherein
when viewed in the direction perpendicular to the first surface, a part of the outer edge of the covering layer coincides with the outer edge of the main body.

7. The inductor component according to claim 1, wherein
when the covering layer is defined as a first covering layer, and
a surface parallel to the first surface among the six outer surfaces is defined as a second surface,
the element body further includes a second covering layer parallel to the first covering layer,
the second covering layer is on a second surface side with respect to an end of the circling path on a second surface side, and
when viewed in the direction perpendicular to the first surface, the second covering layer overlaps the entire circling path, and a range surrounded by an outer edge of the second covering layer is smaller than a range surrounded by an outer edge of the main body.

8. The inductor component according to claim 7, wherein
the entire second covering layer is inside the main body.

9. The inductor component according to claim 7, wherein
the entire second surface is a surface of the second covering layer.

10. The inductor component according to claim 1, wherein
the main body includes a plurality of insulating portions,
the plurality of insulating portions are laminated in the direction perpendicular to the main surface, and
the first surface is the main surface.

11. The inductor component according to claim 1, wherein
a light transmittance of the covering layer at a specific wavelength is smaller than a light transmittance of the main body at the specific wavelength.

12. The inductor component according to claim 1, wherein
the main body includes a plurality of insulating portions, and
the plurality of insulating portions are sintered bodies.

13. The inductor component according to claim 2, wherein
when viewed in the direction perpendicular to the first surface, a part of the outer edge of the covering layer coincides with the outer edge of the main body.

14. The inductor component according to claim 3, wherein
when viewed in the direction perpendicular to the first surface, a part of the outer edge of the covering layer coincides with the outer edge of the main body.

15. The inductor component according to claim 4, wherein
when viewed in the direction perpendicular to the first surface, a part of the outer edge of the covering layer coincides with the outer edge of the main body.

16. The inductor component according to claim 5, wherein
when viewed in the direction perpendicular to the first surface, a part of the outer edge of the covering layer coincides with the outer edge of the main body.
